(19) United States
(12) Patent Application Publication
(10) Pub. No.: US 2026/0036246 A1
(43) Pub. Date: Feb. 5, 2026

(54) MULTIFUNCTIONAL CONVERSION SEAT, UNIVERSAL CLAMP SEAT FOR STABILIZER, AND ROTARY PAN-TILT

(71) Applicant: Espresso (Chongqing) Image Technology Co., Ltd., Chongqing (CN)

(72) Inventor: Kangping ZHOU, Chongqing (CN)

(73) Assignee: Espresso (Chongqing) Image Technology Co., Ltd., Chongqing (CN)

(21) Appl. No.: 19/002,172

(22) Filed: Dec. 26, 2024

(30) Foreign Application Priority Data
Jul. 30, 2024 (CN) 2024218084693

(51) Int. Cl. F16M 11/04; F16M 11/12; G03B 17/56

(52) U.S. Cl. CPC F16M 11/041; F16M 11/126; G03B 17/561; F16M 2200/021

(57) ABSTRACT

The present application discloses a multifunctional conversion seat, a universal clamp seat for a stabilizer, and a rotary pan-tilt. The multifunctional conversion seat includes an adapter base and a switching block. A first inserting groove is formed in the adapter base, and a switching groove is formed in the bottom of the first inserting groove. The switching block is rotatably matched with the switching groove, and the switching block can be folded in the switching groove and can also be overturned relative to the switching groove, so as to form a second inserting groove between the switching block and one side of the first inserting groove; and the first inserting groove and the second inserting groove are respectively used for mounting quick release plates of different specifications in a matched manner.

### CROSS-REFERENCE TO RELATED APPLICATIONS

The present application claims the priorities of Chinese patent application No. 202421808469.3, filed on Jul. 30, 2024, which are incorporated herein by reference in entirety as part of the present application.

### TECHNICAL FIELD

The present application relates to the technical field of photography auxiliary equipment, and in particular, to a multifunctional conversion seat, a universal clamp seat for a stabilizer, and a rotary pan-tilt.

### BACKGROUND

The development of video technology has added countless fun to the life of ordinary people, some people like to take a horizontal screen video, and some people like to take a vertical screen video. When shooting on a tripod and stabilizer, switching between horizontal and vertical screens usually needs to be achieved by changing mounting positions of a camera L-plate or a camera rabbit cage. Currently, the camera L-plate or the camera rabbit cage on the market (the bottom is provided with an inserting block of an Arca specification), because a wiring port is disposed on a side surface of the camera, most of the side surfaces of the camera L-plate or the camera rabbit cage are not provided with a dovetail groove inserting block of an Arca specification, but the side surfaces are almost provided with a small sliding groove with a Nato specification. Therefore, if a clamp seat capable of clamping the dovetail groove inserting block of the Arca specification and the small sliding groove of the Nato specification at the same time is provided, which will bring great convenience to horizontal and vertical screen shooting of such the camera L-plate and the camera rabbit cage.

### SUMMARY

In view of this, the present application discloses a multifunctional conversion seat, a universal clamp seat for a stabilizer, and a rotary pan-tilt, which are used for solving the problems that an existing technical solution cannot meet requirements of clamping a dovetail groove inserting block of an Arca specification and a small sliding groove of a Nato specification at the same time.

On one hand, an embodiment of the present application provides a multifunctional conversion seat, including an adapter base, where a first inserting groove is formed in the adapter base, and a switching groove is formed in the bottom of the first inserting groove; and a switching block, where the switching block is rotatably matched with the switching groove, and the switching block can be folded in the switching groove and can also be overturned relative to the switching groove, so as to form a second inserting groove between the switching block and one side of the first inserting groove; and the first inserting groove and the second inserting groove are respectively used for mounting quick release plates of different specifications in a matched manner.

In some embodiments, a conversion groove is formed in one side of the switching block; the switching block is overturned to enable the conversion groove to be opposite to one side of first inserting groove, so as to form the second inserting groove between the side of the first inserting groove and the conversion groove; and the first inserting groove and the second inserting groove are respectively used for mounting the quick release plate of an ARCA specification and a NATO specification in the matched manner; alternatively, the first inserting groove and the second inserting groove are respectively used for mounting the quick release plate of a Manfrotto specification and an Arca specification in the matched manner.

In some embodiments, an expansion groove in communication with one side of the switching groove is formed in the bottom of the first inserting groove. In some embodiments, a handheld groove is formed in one side of the switching block, and when the switching block is folded in the switching groove, the handheld groove faces the expansion groove.

In some embodiments, the adapter base is further provided with a locking assembly, and at least part of the locking assembly is movable relative to the adapter base and is used for locking the quick release plate of camera equipment (or a sliding groove) in the first inserting groove or the second inserting groove.

In some embodiments, the locking assembly includes a position adjusting assembly; the position adjusting assembly is detachably connected to a side edge of the adapter base, and a space formed for accommodating the quick release plate of the camera equipment can be adjusted by adjusting a distance between the position adjusting assembly and the adapter base.

In some embodiments, the position adjusting assembly includes a bearing member, an abutting member, an elastic buffer member, a connecting rod, and a rotary pushing member, where the bearing member is suitable for bearing one side of the camera equipment and is fixedly connected to one side of the first groove, and one end of the bearing member close to the adapter base is connected to the abutting member; the abutting member is connected to the elastic buffer member, a through hole for accommodating the abutting member and the elastic buffer member is formed in the adapter base, and the abutting member is movably mounted in the through hole; the elastic buffer member is located in the through hole and is used for buffering the abutting member; one end of the connecting rod is fixed to the adapter base, and a rod body of the connecting rod penetrates through the bearing member to be detachably connected to the rotary pushing member; and the rotary pushing member is located on a side of the abutting member away from the adapter base and is used for pushing the abutting member, so as to adjust a distance between the abutting member and two sides of the first groove.

In some embodiments, the position adjusting assembly further includes a plane thrust bearing, the plane thrust bearing is sleeved on the connecting rod, and the plane thrust bearing is sleeved between the rotary pushing member and the bearing member.

In some embodiments, the rotary pushing member includes a rotating head and a stop nail, where a pushing hole is formed in the rotating head in a penetrating manner along a direction of connecting rod, and the rotating head is rotatably sleeved on the connecting rod through the pushing hole; and the stop nail is detachably connected to one end of the connecting rod away from the adapter base, and is used for limiting a position of the rotating head.

In some embodiments, an accommodating groove is formed in the adapter base; and the accommodating groove is used for accommodating the switching block to rotate, and the switching block is rotatably mounted in the accommodating groove through a rotating shaft.

In some embodiments, the locking assembly includes a locking driving member, where the locking driving member is movably disposed along a direction perpendicular to the first inserting groove, and is used for locking and unlocking the camera equipment inserted into the first inserting groove or the second inserting groove.

In some embodiments, the locking driving member includes a locking mechanism, a button unlocking mechanism, and a transition block, where two ends of the transition block are respectively connected to the locking mechanism and the button unlocking mechanism; the locking mechanism includes a limiting block, the limiting block is connected to the transition block, and after the switching block is overturned, the conversion groove faces the limiting block; an accommodating cavity is formed in one side of the adapter base, and an elastic member is disposed between the locking driving member and the adapter base; and the button unlocking mechanism can compress the elastic member and push the limiting block to slide into the accommodating cavity, and when the clastic member is reset, the limiting block can slide out of the accommodating cavity and abuts against the first inserting groove.

In some embodiments, the button unlocking mechanism includes a button and a button connecting member, where the button is transversely and slidably matched with the button connecting member, and the button connecting member is connected to the transition block; a shifting groove is formed in one side of the adapter base, and the button can penetrate out of the shifting groove; and the button is transversely shifted to enable the button to move in the shifting groove, so that an end portion of the button abuts against the bottom of the shifting groove.

In some embodiments, an end portion of the button connecting member is provided with a positioning concave hole, and one end of the button is provided with a positioning member; the positioning member includes a positioning wave bead, a positioning cylinder, and a positioning spring, where the positioning cylinder is connected to the button, the positioning spring is located in the positioning cylinder, and the positioning wave bead is connected to the positioning cylinder through the positioning spring; and the button is transversely shifted to enable the positioning wave bead to be clamped in the positioning concave hole, so as to position the button and the button connecting member.

In some embodiments, a limiting member is connected to the adapter base, and the limiting member is used for limiting a folding position and an overturning position of the switching block.

In some embodiments, a first positioning hole and a second positioning hole are formed in an outer side of the switching block; the limiting member includes a mounting cylinder, a limiting wave bead and a limiting spring, where the limiting spring is located in the mounting cylinder, and two ends of the limiting spring are respectively connected to the mounting cylinder and the limiting wave bead; and when the switching block is in the folding position, the limiting wave bead can be clamped into the first positioning hole, and when the switching block is in the overturning position, the limiting wave bead can be clamped into the second positioning hole.

In some embodiments, an inserting block is connected to the bottom of the adapter base; and a single-side groove is formed between the inserting block and one side of the bottom of the adapter base, and two ends of the single-side groove are communicated with each other.

In some embodiments, groove notches are formed in two adjacent edges located at the bottom of the inserting block.

On one hand, the present application further provides a universal clamp seat for a stabilizer, including the above multifunctional conversion seat and a quick release base, where the quick release base is connected to the multifunctional conversion seat, access ports are formed in two adjacent edges of one side of the quick release base away from the multifunctional conversion seat, one side of the quick release base away from the multifunctional conversion seat is provided with a quick connection groove, and the quick connection groove is in communication with the access ports.

On one hand, the present application further provides a rotary pan-tilt, including a dovetail groove clamp seat, where the bottom of the dovetail groove clamp seat is provided with an accommodating cavity with a downward opening, a rotating disk is rotatably connected to the opening of the accommodating cavity, and a lock mechanism used for being mutually locked with the rotating disk is mounted on the dovetail groove clamp seat; an angle adjusting mechanism is connected to the bottom of the rotating disk, and the angle adjusting mechanism includes a hemispheroid fixedly connected to the rotating disk, and a base coupled to the hemispheroid; and the rotating disk supports the multifunctional conversion seat of the above embodiments and the multifunctional conversion seat can be driven to rotate, a rotation range corresponds to an angle adjustment range of the angle adjusting mechanism, and the angle adjustment range includes 360 degrees and non-360 degrees.

### BRIEF DESCRIPTION OF THE DRAWINGS

To describe the technical solutions in the embodiments of the present application more clearly, the accompanying drawings required to describe the merely embodiments are briefly described below. Apparently, the accompanying drawings described below are only some embodiments of the present application. Those skilled in the art may further obtain other accompanying drawings based on these accompanying drawings without creative efforts.

FIG. 1 is a perspective view I of an embodiment of a multifunctional conversion seat according to the present application with a switching block being folded;

FIG. 2 is a perspective view of an embodiment of a multifunctional conversion seat according to the present application with a switching block being taken out;

FIG. 3 is a perspective view II of an embodiment of a multifunctional conversion seat according to the present application with a switching block being folded;

FIG. 4 is a perspective view of an embodiment of a multifunctional conversion seat according to the present application with a switching block being overturned;

FIG. 5 is a sectional view of a longitudinal section of a locking driving member in an embodiment of a multifunctional conversion seat according to the present application;

FIG. 6 is a top view of a locking driving member and a switching block in an embodiment of a multifunctional conversion seat according to the present application;

FIG. 7 is a sectional view of a longitudinal section of an embodiment of a multifunctional conversion seat according to the present application with a switching block being folded;

FIG. 8 is a sectional view of a longitudinal section of an embodiment of a multifunctional conversion seat according to the present application with a switching block being overturned;

FIG. 9 is schematic bottom view of an embodiment of a multifunctional conversion seat according to the present application;

FIG. 10 is schematic top view of an embodiment of a universal clamp seat for a stabilizer according to the present application;

FIG. 11 is a schematic exploded view of an embodiment of a universal clamp seat for a stabilizer according to the present application;

FIG. 12 is a schematic sectional view of an embodiment of a universal clamp seat for a stabilizer according to the present application;

FIG. 13 is a schematic diagram of partial structural disassembly of an embodiment of a universal clamp seat for a stabilizer according to the present application;

FIG. 14 is a partial structural perspective view of an embodiment of a universal clamp seat for a stabilizer according to the present application;

FIG. 15 is a partial structural perspective view of an embodiment of a universal clamp seat for a stabilizer according to the present application;

FIG. 16 is a perspective schematic diagram of an embodiment of a universal clamp seat for a stabilizer according to the present application;

FIG. 17 is a schematic structural diagram of an embodiment of a rotary pan-tilt according to the present application; and

FIG. 18 is a schematic partial sectional view of an embodiment of a rotary pan-tilt according to the present application.

### REFERENCE NUMERALS AND CORRESPONDING PART NAMES IN THE DRAWINGS

1—adapter base; 101—sliding hole; 102—accommodating cavity; 3—switching groove; 301—expansion groove; 4—switching block; 401—handheld groove; 402—conversion groove; 5—fixed screw rod; 501—screw rod head; 901—limiting block; 902—fixed screw; 905—transition block; 906—elastic member; 907—positioning concave hole; 908—positioning wave bead; 909—positioning spring; 910—positioning cylinder; 02—position adjusting assembly; 03—first clamping arm; 04—second clamping arm; 05—clamping limiting assembly; 06—quick release base; 11—accommodating groove; 12—mounting hole; 13—limiting member; 21—bearing member; 22—abutting member; 23—elastic member; 24—connecting rod; 25—rotary pushing member; 251—rotating head; 252—pushing hole; 253—stop nail; 41—rotating shaft; 51—rotating shaft stabilizing sleeve; 52—first clamping groove; 53—wave bead mounting groove; 54—wave bead buffering member; 55—wave bead; 56—second clamping groove; 61—access port; 62—quick connection groove; 72—accommodating cavity; 721—positioning member; 73—rotating disk; 75—lock mechanism; 751—closure plate; 752—rotating shaft; 753—locking member; 754—operating component; 76—angle adjusting mechanism; 761—hemispheroid; 762—base; 763—semi-concave spherical surface; 7631—through hole; 7632—sleeve; 7633—bolt; 7634—rotary knob; 764—clastic member; 765—connecting component; 766—pushing component.

### DETAILED DESCRIPTION OF THE EMBODIMENTS

The following clearly and completely describes the technical solutions in the embodiments of this application with reference to the accompanying drawings in the embodiments of this application. Apparently, the described embodiments are only a part rather than all of the embodiments of this application. All other embodiments obtained by those skilled in the art based on the embodiments of the present application without creative efforts shall fall within the protection scope of the present application.

### Embodiment 1

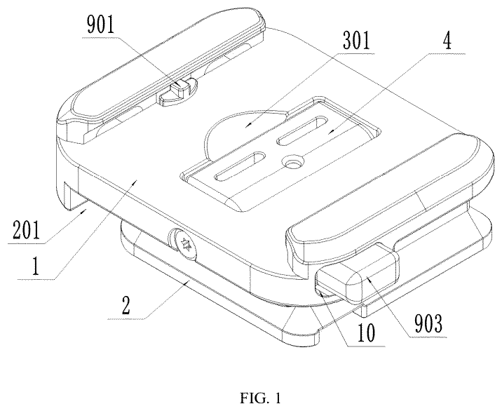

As shown in FIG. 1 to FIG. 4, this embodiment provides a multifunctional conversion seat, including an adapter base 1 and a switching block 4, where a first inserting groove is formed in the adapter base 1, the inserting groove is a dovetail groove, and the first inserting groove is of a through groove structure. A switching groove 3 is formed in the bottom of the first inserting groove, the switching groove 3 is located in a middle position of the first inserting groove, and the switching groove 3 is a rectangular groove. The switching block 4 is rotatably matched with the switching groove 3, and the switching block 4 can be folded in the switching groove 3 and can also be overturned relative to the switching groove 3, so as to form a second inserting groove between the switching block and one side of the first inserting groove. As shown in the figure, the switching block can be overturned by 90 degrees in the switching groove 3, so as to form the second inserting groove between the switching block and one side of the first inserting groove. When the switching block 4 is folded in the switching groove 3, the height of the switching block is lower than that of the notch of the switching groove 3, so that flatness of the bottom of the first inserting groove can be ensured. The first inserting groove and the second inserting groove are respectively used for mounting quick release plates of different specifications in a matched manner, so as to achieve quick mounting of the quick release plates of different specifications.

Specifically, the first inserting groove and the second inserting groove are respectively used for mounting the quick release plate of an ARCA specification and a NATO specification in the matched manner; alternatively, the first inserting groove and the second inserting groove are respectively used for mounting the quick release plate of a Manfrotto specification and an Arca specification in the matched manner. Therefore, the multifunctional conversion seat can be adapted to three types of quick release interfaces in the field of photography, which is high in adaptability.

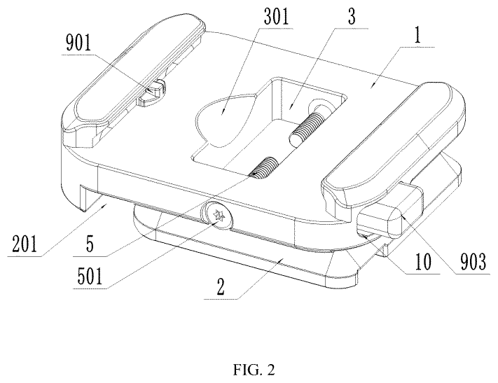

As shown in FIG. 2, in this embodiment, two ends of the switching block 4 are in threaded connection with fixed screw rods 5, one end of each fixed screw rod 5 is coaxially connected to a screw rod head 501, a through hole in communication with the screw rod head is formed in two sides of the switching groove 3, the screw rod head 501 is located in the through hole and is rotatably matched with the through hole, and the switching block 4 is rotatably matched with the two sides of the switching groove 3 through the two fixed screw rods 5 and the screw rod head 501, so as to facilitate overturning or folding of the switching block 4. An expansion groove 301 in communication with one side of the switching groove 3 is formed in the bottom of the first inserting groove, the expansion groove 301 is arc-shaped, and through the arrangement of the expansion groove 301, a user can conveniently rotate the switching block 4 by hand, so that one end of the switching block 4 is overturned out of the switching groove 3.

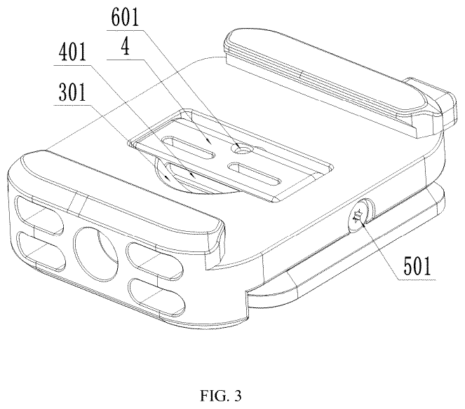

Further, as shown in FIG. 3, a handheld groove 401 is formed in one side of the switching block 4, and the handheld groove 401 is strip-shaped. When the switching block 4 is folded in the switching groove 3, the handheld groove 401 faces the expansion groove 301, in this way, when the switching block 4 is overturned, a finger is inserted into the handheld groove 401, so that the switching block 4 is overturned upwards, and operation is more convenient.

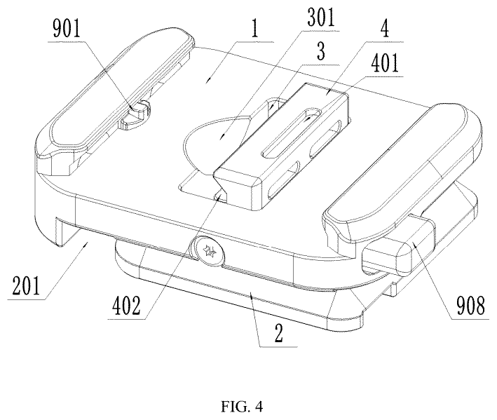

As shown in FIG. 4, a conversion groove 402 is formed in one side of the switching block 4, and after the switching block 4 is overturned, the conversion groove 402 can be symmetrically disposed with one side of the first inserting groove. The bottom of the conversion groove 402 is a flat surface, and one side of the conversion groove 402 is an inclined surface. In this way, after the switching block 4 is overturned, the second inserting groove formed by the conversion groove 402 of the switching block 4 and one side of the first inserting groove is also a dovetail groove structure.

In some embodiments, the adapter base 1 is further provided with a locking assembly (not shown in the figure), and at least part of the locking assembly is movable relative to the adapter base 1 and is used for locking the quick release plate of camera equipment (or a sliding groove) in the first inserting groove or the second inserting groove.

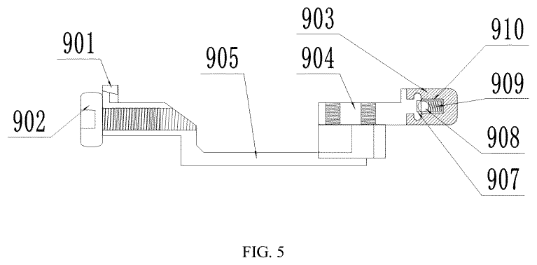

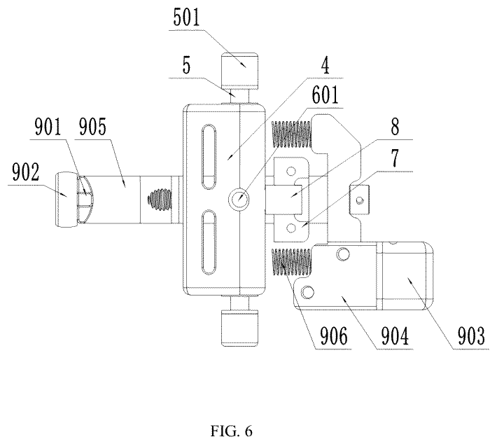

In some embodiments, the locking assembly includes a locking driving member, and the locking driving member is slidably matched with the adapter base 1 along a direction perpendicular to the first inserting groove. The interior of the adapter base 1 is provided with a cavity for accommodating the locking driving member, and the locking driving member can slide in the cavity. As shown in FIG. 5 and FIG. 6, an elastic member 906 is disposed between the locking driving member and the adapter base 1, and in this embodiment, the elastic member 906 is a spring. The locking driving member can lock and unlock the quick release plate inserted into the first inserting groove or the second inserting groove.

Specifically: the locking driving member includes a locking mechanism, a button unlocking mechanism, and a transition block 905. Two ends of the transition block 905 are respectively connected to the locking mechanism and the button unlocking mechanism. The locking mechanism and the button unlocking mechanism are movably disposed on two sides of the adapter base 1, and the position between the locking mechanism and the button unlocking mechanism can be flexibly set according to actual needs.

The locking mechanism includes a limiting block 901 and a fixed screw 902, and a rod portion of the fixed screw 902 is in threaded connection with the transition block 905. As shown in FIG. 1, in this embodiment, an upper portion of the limiting block 901 is of a convex structure, and a side of the limiting block 901 facing the transition block 905 is an arc convex surface. Two symmetry planes of the top of the limiting block 901 are both inclined surfaces. In this way, when the limiting block is matched with the limiting groove of the quick release plate, the limiting block and the limiting groove can be mutually clamped more tightly, and the positioning effect is better.

After the switching block 4 is overturned, the conversion groove 402 faces the limiting block 901, so that the quick release plate inserted into the second inserting groove can be conveniently locked. The limiting block 901 is connected to the transition block 905, and in this embodiment, the limiting block 901 is integrally formed with the transition block 905 or is connected to the transition block 905 through the fixed screw 902.

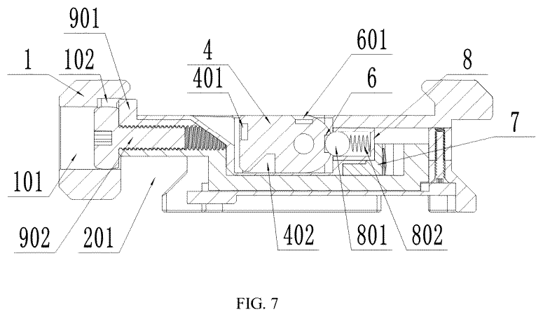

As shown in FIG. 7, in this embodiment, an accommodating cavity 102 and a sliding hole 101 are formed in one side of the adapter base 1, and the accommodating cavity 102 is in communication with the sliding hole 101. The limiting block 901 can move in the accommodating cavity 102 along a direction perpendicular to the first inserting groove, and an axial direction of the sliding hole 101 is consistent with an operation direction of the limiting block 901. The head of the fixed screw 902 is located in the sliding hole 101 and is slidably matched with the axial direction of the sliding hole 101, the head of the fixed screw 902 is a cylindrical structure with arc-shaped edges on two sides. The width of the head of the fixed screw 902 is greater than the width of a lower portion of the limiting block 901, and the fixed screw 902 is in threaded connection with the lower portion of the limiting block 901.

The button unlocking mechanism is press to compress the elastic member 906 and push the limiting block 901 to slide into the accommodating cavity 102, and when the elastic member 906 is reset, the limiting block 901 can slide out of the accommodating cavity 102 and be located on an inner side of the first inserting groove.

As shown in FIG. 5 and FIG. 6, the button unlocking mechanism includes a button 903 and a button connecting member 904, where the button 903 is transversely and slidably matched with the button connecting member 904, and the button connecting member 904 is connected to a transition block 905. In this embodiment, a T-shaped groove is formed in one end of the button 903, one end of the button connecting member 904 is T-shaped, and one end of the T-shaped of the button connecting member 904 is inserted into the T-shaped groove of the button 903 and is transversely and slidably matched with the T-shaped groove.

A shifting groove 10 is formed in one side of the adapter base 1, and the button 903 can penetrate out of the shifting groove 10; and the button 903 is transversely shifted to enable the button 903 to transversely displace in the shifting groove 10, so that an end portion of the button 903 abuts against the bottom of the shifting groove 10, and the button 903 can be locked. In this way, when a locking state needs to be achieved, misoperation safety can be provided for the button 903, so that the button 903 cannot be pressed, a double locking effect is achieved, and connection between the accessories is safer and more stable.

In this embodiment, a plurality of transversely distributed positioning concave holes 907 are formed in an end portion of the button connecting member 904, a positioning member is disposed at one end of the button 903, and the number of the positioning members is less than that of the positioning concave holes 907. The positioning member includes a positioning wave bead 908, a positioning cylinder 910, and a positioning spring 909, where the positioning cylinder 910 is connected to the button 903. In this embodiment, the positioning cylinder 910 is inserted into one side of the T-shaped groove of the button 903, the positioning spring 909 is located in the positioning cylinder 910, and the positioning wave bead 908 is connected to the positioning cylinder 910 through the positioning spring 909. When the positioning spring 909 is not compressed, a part of the positioning wave bead 908 protrudes out of the T-shaped groove of the button 903. The button 903 is transversely shifted to enable the positioning wave bead 908 to be clamped in the positioning concave hole 907 to position the button 903 and the button connecting member 904, so as to prevent the button 903 from sliding reversely by itself after shifting the button 903 to a designated position.

In this embodiment, the first inserting groove and the second inserting groove share the same set of locking driving mechanism, that is, after the switching block 4 is overturned, a conversion groove 402 on the switching block 4 is directly opposite to a side of the first inserting groove with a limiting block 901.

A specific implementation process is as follows: in this embodiment, the adapter base 1 can be used for quick release plates of two specifications (a quick release plate of an Arca specification and a quick release plate of a Nato specification, where the width of the quick release plate of the Arca specification is greater than that of the quick release plate of the Nato specification), and one side of the quick release plate is generally provided with a limiting groove in clamping matched with the limiting block 901. When the quick release plate of the Arca specification is used, the switching block 4 is folded in the switching groove 3, and the quick release plate of the Arca specification is directly inserted into the first inserting groove. In the process of inserting the first inserting groove, when the quick release plate is in contact with the limiting block 901, the limiting block 901 is gradually extruded, and the elastic member 906 is compressed, so that the limiting block 901 gradually retracts into the accommodating cavity 102. In this case, the quick release plate can smoothly pass through, when the limiting groove on the quick release plate moves to a position directly opposite to the limiting block 901, the limiting block 901 is reset under the action of the elastic member 906 and clamped into the limiting groove to lock and position the quick release plate.

When the quick release plate of the Nato specification is used, the switching block 4 is overturned, so that the conversion groove 402 on the switching block 4 is directly opposite to the side of the first inserting groove with a limiting block 901, so as to form the second inserting groove. In this way, a relatively narrow quick release plate of the Nato specification is inserted into the second inserting groove, and the limiting block 901 is clamped in the limiting groove of the quick release plate to achieve the locking effect.

In the described operation process, when the button 903 needs to provide misoperation safety in the locking state, the button 903 is transversely shifted to enable the button 903 to laterally displace in the shifting groove 10, so as to be clamped on the bottom of the shifting groove 10. In this case, the button 903 cannot be pressed, so that a double-safe effect is achieved, and a loss such as equipment falling due to a detachment of the quick release plate and the adapter base 1 caused by incorrect pressing of the button 903 is avoided.

When the quick release plate needs to be taken out, the button 903 is reversely shifted, so that the button 903 can be pressed, and then, the button 903 is pressed, so that the button 903 drives the button connecting member 904 to push the transition block 905 and the limiting block 901 to move towards an outer side of the limiting groove of the quick release plate. When the limiting block 901 is completely disengaged from the limiting groove of the quick release plate, the quick release plate can be smoothly taken out to complete dismounting work.

In this embodiment, on the same quick release device, the use requirements of quick release plates of different specifications can be met. Normally, the switching block 4 is hidden in the switching groove 3, and when the quick release plate of the card specification is used by the camera, quick mounting and dismounting can be carried out on the adapter base 1. The switching block 4 in the middle is opened, and the adapter base 1 is provided with a sliding strip (a quick release plate) for clamping the Nato specification. When a side edge of a camera rabbit cage is provided with the sliding strip of the Nato specification, the sliding strip of the Nato specification on the side edge can be quickly mounted into the second inserting groove on the adapter base 1 for vertical screen shooting.

In this embodiment, the camera can be quickly switched between horizontal screen shooting and vertical screen shooting by utilizing the quick release plate of the Arca specification under the rabbit cage and the sliding strip of the Nato specification on a side surface, which greatly improves the shooting efficiency and improves the user experience.

### Embodiment 2

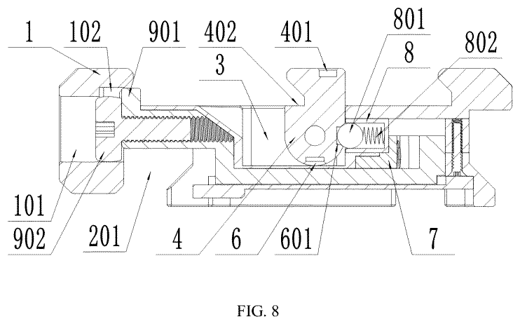

As shown in FIG. 7 and FIG. 8, a difference between this embodiment and Embodiment 1 is that: the switching block 4 can be overturned by 90 degrees, and an adapter base 1 is connected with a limiting member for limiting a folding position and an overturning position of the switching block 4.

In this embodiment, a first positioning hole 6 and a second positioning hole 601 are formed in an outer side of the switching block 4, and the first positioning hole 6 and the second positioning hole 601 are arranged at 90 degrees. The limiting member includes a mounting cylinder 8, a limiting wave bead 801 and a limiting spring 802. A connecting seat 7 is connected to the adapter base 1 through a screw, the mounting cylinder 8 is connected to the connecting seat 7, and the mounting cylinder 8 and the connecting seat 7 are integrally formed, or connected through a screw, or connected and fixed through a glue connection or the like. The limiting spring 802 is located in the mounting cylinder 8, and two ends of the limiting spring 802 are respectively connected to the mounting cylinder 8 and the limiting wave bead 801. As shown in FIG. 7, when the switching block 4 is in the folding position, the limiting wave bead 801 can be clamped into the first positioning hole 6, and as shown in FIG. 8, when the switching block 4 is in the overturning position, the limiting wave bead 801 can be clamped into the second positioning hole 601.

In this embodiment, after the switching block 4 is folded and overturned, the first positioning hole 6 and the second positioning hole 601 can be directly opposite to the limiting wave bead 801 in sequence, so that the limiting wave bead 801 is conveniently clamped into the first positioning hole 6 or the second positioning hole 601. In this way, positioning and clear gear hand feeling are provided for the process of folding and overturning the switching block 4, thereby effectively improving the user experience, and improving the stability of the switching block 4 in the folding position and the overturning position.

### Embodiment 3

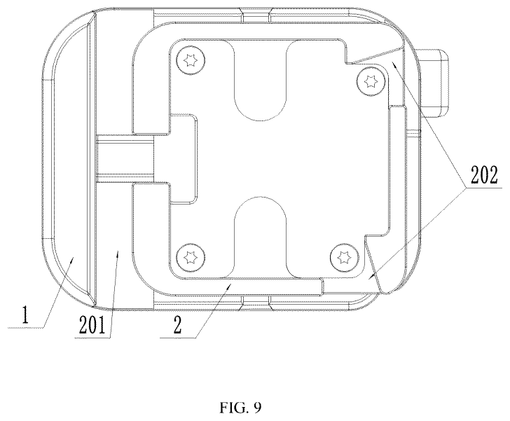

As shown in FIG. 1 and FIG. 9, a difference between this embodiment and Embodiment 1 is that: an inserting block 2 is connected to the bottom of the adapter base 1, and the inserting block 2 and the adapter base 1 are integrally formed or integrally connected in other connection manners. A single-side groove 201 is formed between the inserting block 2 and one side of the bottom of the adapter base 1, and two ends of the single-side groove 201 are communicated with each other, that is, one side of the adapter base 1 extends downwards to form a through groove structure with one side of the inserting block 2. In addition, in this embodiment, groove notches 202 are formed in two adjacent edges located at the bottom of the inserting block 2. In this embodiment, the inserting block 2 is of a rectangular block structure as a whole, and the two groove notches 202 are located on two adjacent right-angle edges of the inserting block 2.

In this embodiment, when the adapter base 1 is in butt joint with a stabilizer base without a quick-release function, an “anti-disengaging shifting rod” in the stabilizer base (that is, a shifting rod structure at the bottom of the stabilizer and used for being in butt joint with and matched with the adapter base) can smoothly slide in from any of the two notches to complete butt joint work. In addition, in this embodiment, the single-side groove 201 formed between the inserting block 2 and one side of the bottom of the adapter base 1 can be embedded with a stabilizer of a specific specification, so as to meet a butt joint requirement, and due to the arrangement of the embedded structure, the height of the adapter base 1 can be greatly reduced, the gravity center of the camera is reduced, and the mounting space of the stabilizer is maximized, which is of great significance for a hand-held camera stabilizer.

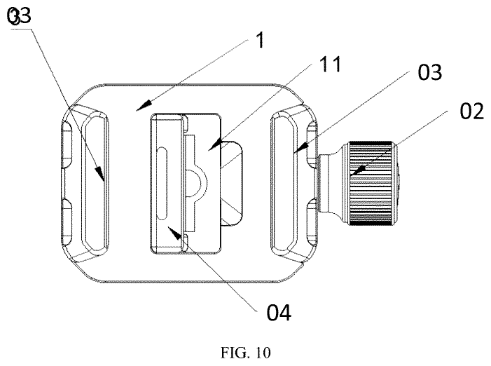

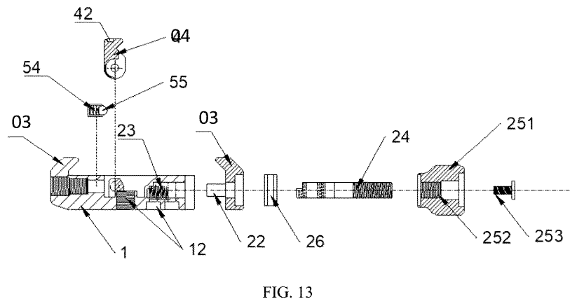

In some embodiments, referring to FIG. 10 to FIG. 13, the locking assembly includes a position adjusting assembly, and the position adjusting assembly 02 includes a bearing member 21, an abutting member 22, an elastic member 23, a connecting rod 24, and a rotary pushing member 25. The bearing member 21 bears one side of the camera, preferably, the bearing member 21 and the adapter base 1 have the same thickness, and the bearing member and the adapter base can be tightly attached. The top of the bearing member 21 is fixedly connected to a first clamping arm 3 (equivalent to one side of the first inserting groove), and one side surface of the bearing member 21 close to the adapter base 1 is fixedly connected to the abutting member 22, and the connection manner can be welding, integral forming, or the like. The abutting member 22 is disposed in parallel relative to the adapter base 1, so that when the distance between the adapter base 1 and the bearing member 21 needs to be reduced, the bearing member 21 can be stably and tightly attached to a side edge of the adapter base 1. A through hole is formed in the adapter base 1, the through hole is used for accommodating the connecting rod 24 to penetrate through, and preferably, the through hole is located in the middle section of the adapter base 1. The abutting member 22 is connected to the elastic member 23, and under the pushing action of the rotary pushing member 25, the abutting member 22 can apply an acting force to the elastic member 23, so as to shorten the distance between the bearing member 21 and the adapter base 1, and when the distance between the bearing member and the adapter base needs to be increased, the clastic member 23 applies a reverse acting force to the abutting member 22. Under the condition that the thrust of the rotary pushing member 25 is lacked, the abutting member 22 can be driven to move outwards, so as to increase the distance between the bearing member 21 and the adapter base 1. Preferably, the adapter base 1 is provided with a through hole for accommodating the abutting member 22 and the elastic member 23. Preferably, there are two abutting members 22 and two elastic members 23, and the two abutting members 22 are symmetrically disposed, which can provide a positioning effect, and the abutting members are not offset. The elastic member 23 is located in the through hole of the adapter base 1 and is used for buffering the abutting member 22. Preferably, the elastic member 23 can be a spring. One end of the connecting rod 24 is fixed on the adapter base 1, and the fixed end may be fixed through a screw or a threaded hole or the like. A rod body of the connecting rod 24 penetrates through the bearing member 21 to be detachably connected to the rotary pushing member 25. Specifically, the connecting rod and the rotary pushing member can be in threaded connection, and the bearing member 21 can be driven to move forwards/backwards under the rotation of the rotary pushing member 25. The rotary pushing member 25 is located on a side of the abutting member 22 away from the adapter base 1. When the rotary pushing member rotates in a forward direction, the bearing member 21 can be driven to move forwards, and when the rotary pushing member rotates in a reverse direction, the bearing member 21 can be driven to move backwards, so as to push the abutting member 22 to adjust the distance between the bearing member and the adapter base 1.

In some embodiments, referring to FIG. 10 to FIG. 12, the connecting rod 24 is further sleeved with a plane thrust bearing 26 between the rotary pushing member 25 and the bearing member 21. When a user needs to adjust the distance between the bearing member 21 and the adapter base 1, the plane thrust bearing 26 can push the abutting member 22 and the bearing member 21 to move under the action of the rotary pushing member 25, so that friction between the rotary pushing member 25 and the bearing member 21 is reduced, the screwing process is smoother and more labor-saving, the hand feeling is better, and rotation is easier. The friction between the rotary pushing member 25 and the bearing member 21 is reduced, so that the service life of the clamping groove is prolonged.

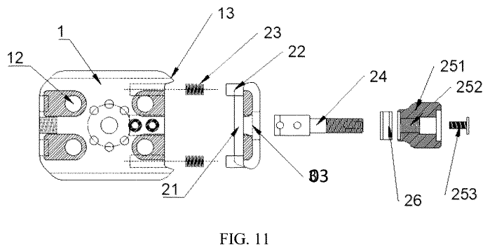

In some embodiments, referring to FIG. 10 and FIG. 11, the rotary pushing member 25 including a rotating head 251 and a stop nail 253. A pushing hole 252 is formed in the rotating head 251 in a penetrating manner along a direction of connecting rod 24, an internal thread is preferably disposed in the pushing hole 252, and the internal thread is connected to a thread on the connecting rod 24, so that the rotating head 251 can move back and forth relative to the connecting rod 24. The stop nail 253 is detachably connected to one end of the connecting rod 24 away from the adapter base 1. Preferably, a threaded hole is formed in an end portion of the connecting rod 24, so that the stop nail 253 can be connected to the connecting rod, and the rotating head 251 is located between the plane thrust bearing 26 and the stop nail 253, when the rotating head 251 moves to the maximum position, the rotating head 251 is clamped by the stop nail 253, so that the rotating head cannot continue to move, thereby ensuring that the rotating head 251 cannot be disengaged from the connecting rod 24.

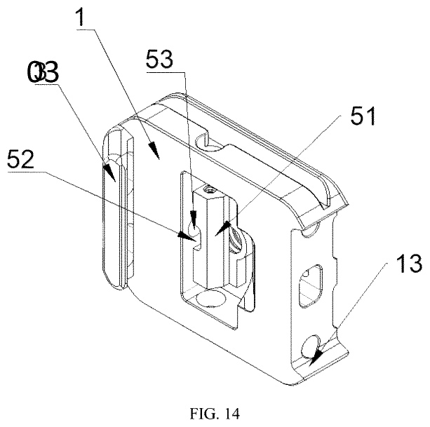

In some embodiments, referring to FIG. 10 and FIG. 14, the adapter base 1 is provided with an accommodating groove 11, the accommodating groove 11 is a recessed groove body and may be rectangular in shape, and the accommodating groove is used for accommodating a second clamping arm 04 (equivalent to the foregoing switching block). The second clamping arm 04 is rotatably mounted in the accommodating groove 11 through a rotating shaft 41, and when the included angle between the second clamping arm 04 and the adapter base 1 is 0 degree, the second clamping arm 04 and the top of the accommodating groove 11 are in a straight line, so that the camera can be stably mounted on the adapter base 1. When the second clamping arm 04 rotates to be vertical, a second clamping space is formed between the first clamping arm 03 on the bearing member 21 and the second clamping arm, and the second clamping space can be used for clamping a small sliding groove of a Nato specification.

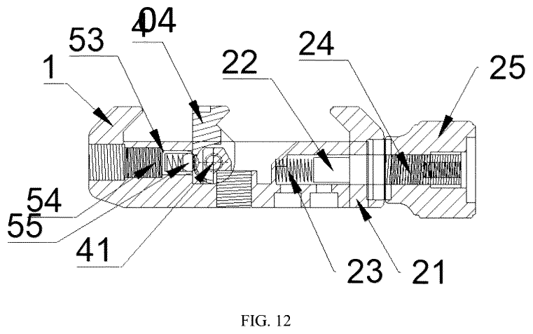

In some embodiments, referring to FIG. 12 to FIG. 15, a clamping limiting assembly 05 is further mounted in the accommodating groove 11. The clamping limiting assembly 05 is connected to the second clamping arm 04, and clamping of the second clamping arm 04 can be achieved when the second clamping arm rotates to 0 degree and 90 degrees, so as to fix the camera.

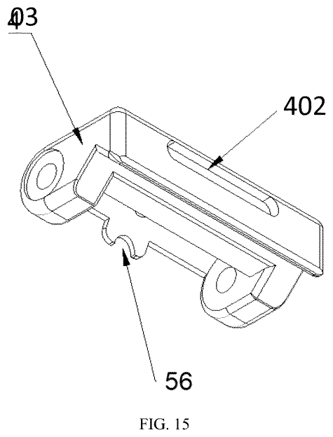

In some embodiments, referring to FIG. 12 to FIG. 15, the clamping limiting assembly includes a rotating shaft stabilizing sleeve 51, a first clamping groove 52, a wave bead mounting groove 53, a wave bead buffering member 54, a wave bead 55, and a second clamping groove 56. The rotating shaft 41 rotatably penetrates through the rotating shaft stabilizing sleeve 51, and the rotating shaft stabilizing sleeve 51 is located below the second clamping arm 04. Preferably, the rotating shaft stabilizing sleeve 51 is located in the middle section of the accommodating groove 11, and a cross section of the rotating shaft stabilizing sleeve is trapezoidal, so that the second clamping arm 04 can rotate relative to the rotating shaft stabilizing sleeve. The first clamping groove 52 is formed in the rotating shaft stabilizing sleeve 51, and referring to FIG. 14, the first clamping groove is used for being clamped with the wave bead 55 when the second clamping arm 04 does not rotate. The wave bead mounting groove 53 is formed in the adapter base 1, and the wave bead mounting groove 53 is in communication with the accommodating groove 11 to enable the wave bead 55 to partially push out the wave bead mounting groove 53 under the acting force of the wave bead buffering member 54 when the second clamping arm 04 does not rotate, so that the wave bead is clamped with the second clamping groove 56 or the first clamping groove 52. The wave bead buffering member 54 is located in the wave bead mounting groove 53 and is used for buffering the wave bead 55. Preferably, the wave bead buffering member can be a spring. The wave bead 55 is located in the wave bead mounting groove 53, and when the second clamping arm 04 does not rotate, the wave bead buffering member 54 provides outward acting force for the wave bead 55 to drives the wave bead 55 to be partially located outside the wave bead mounting groove 53 and located in the accommodating groove 11, and in this case, the wave bead 55 is clamped with the second clamping groove 56 or the first clamping groove 52. When the second clamping arm 04 rotates, the second clamping groove 56 can extrude the wave bead 55, so that the wave bead 55 is squeezed into the wave bead mounting groove 53. The second clamping groove 56 is formed in the bottom of the second clamping arm 04, and referring to FIG. 15.

In some embodiments, referring to FIG. 15, the second clamping groove 56 is in a downward arc shape, and a side edge of the second clamping groove is in an inward arc shape.

In some embodiments, referring to FIG. 10, a mounting hole 12 is formed in one side of the adapter base 1 on which the external supporting equipment is mounted, and the mounting hole can be used for connecting the adapter base to a bracket through a screw, so as to achieve stable shooting of a camera.

In some embodiments, referring to FIG. 15, a handheld groove 401 is formed in the second clamping arm 04, and the handheld groove 401 is located on one side of the second clamping arm 04 close to the first clamping arm 03 mounted on the adapter base 1, so that a user can conveniently rotate the second clamping arm 04 with a force.

In some embodiments, referring to FIG. 10 and FIG. 15, a limiting member 13 is mounted on the side of the adapter base 1 opposite to the position adjusting assembly 02, the limiting member 13 is arc-shaped and connected to a side edge of the bearing member 21, and movement of the bearing member 21 can be stabilized. Preferably, two limiting members 13 are disposed, and the two limiting members 13 are symmetrically disposed on the two edges of the adapter base 1.

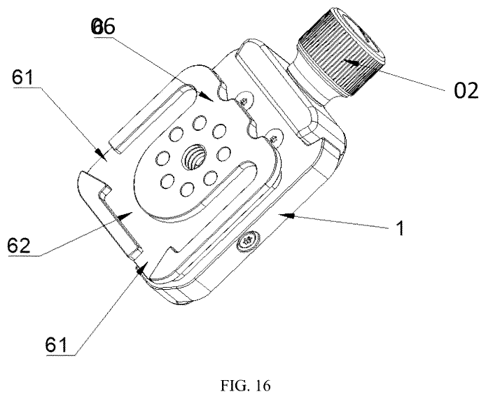

In a second aspect, this embodiment provides a universal clamp seat for a stabilizer, and referring to FIG. 10 to FIG. 16, the universal clamping base includes the universal double-groove clamp seat. For a structure of the double-groove clamp seat, refer to FIG. 10 to FIG. 15 and partial description of the forgoing embodiments.

A quick release base 06 is fixed to the universal double-groove clamp seat through a screw and is used for mounting the stabilizer. Preferably, a DJI stabilizer can be mounted. Access ports 61 are formed in two adjacent edges of one side of the quick release base 06 away from the universal double-groove clamp seat, and the access ports 61 are used for clamping the stabilizer. One side of the quick release base 06 away from universal double-groove clamp is provided with a quick connection groove 62, the quick connection groove 62 is U-shaped, and the quick connection groove 62 is in communication with the access ports 61, so as to clamp the stabilizer.

Preferably, the inner diameter of one end of the access port 61 close to an edge of the quick release base 06 is large, and the inner diameter of one end of the access port away from an edge of the quick release base 06 is small.

Preferably, the included angle between the two access ports 61 is 90 degrees, and the direction of the clamp seat can be adjusted when necessary.

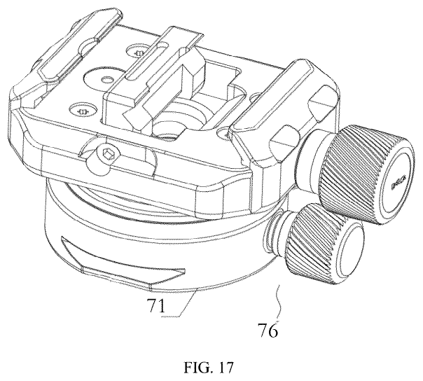

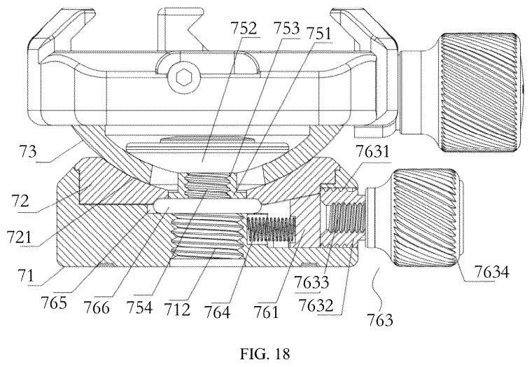

In a third aspect, this embodiment further provides a rotary pan-tilt, referring to FIG. 17 and FIG. 18. The rotary pan-tilt includes a dovetail groove clamp scat 71, where the bottom of the dovetail groove clamp seat 71 is provided with an accommodating cavity 72 with a downward opening, a rotating disk 73 is rotatably connected to the opening of the accommodating cavity 72, and a lock mechanism 75 used for being mutually locked with the rotating disk 73 is mounted on the dovetail groove clamp seat 71; an angle adjusting mechanism 76 is connected to the bottom of the rotating disk 73, and the angle adjusting mechanism 76 includes a hemispheroid 761 fixedly connected to the rotating disk 73, and a base 762 coupled to the hemispheroid 761, the top of the base 762 is provided with a semi-concave spherical surface 763, the hemispheroid 761 is in smooth contact with the semi-concave spherical surface 763, and the dovetail groove clamp seat 71 and the rotating disk 73 can rotate relative to each other through surface cooperation between the hemispheroid 761 and the semi-concave spherical surface 763; and the rotating disk 73 rotates to support the multifunctional conversion seat of the above embodiments and the multifunctional conversion seat can be driven to rotate, a rotation range corresponds to an angle adjustment range of the angle adjusting mechanism, and the angle adjustment range includes 360 degrees and non-360 degrees.

Therefore, through the cooperation between the hemispheroid 761 and the base 762 coupled to the hemispheroid, it can be ensured that an adapter clamp seat has an angle adjustment capability while reducing the volume. The head of the hemispheroid 761 extends into the base 762, and the tail of the hemispheroid extends into the dovetail groove clamp seat 71, so that the height of the rotary pan-tilt can be further reduced, the structure of the rotary pan-tilt is more compact and smaller, the gravity center is reduced, and the stability in the shooting process is ensured. In addition, the angle adjustment range of the angle adjusting mechanism 76 includes 360 degrees and non-360 degrees, so that the dovetail clamping groove base 71 and the rotating disk 73 can freely rotate relative to each other. The angle adjusting structure is matched with the lock mechanism 75, so that the camera can be accurately rotated to adjust the shooting angle of the camera, and various shooting requirements can be met.

In one embodiment, referring to FIG. 18, a top surface of the rotating disk 73 is provided with a positioning ring groove, a top wall of the accommodating cavity 72 protrudes downwards to form a positioning member 721, and the positioning member 721 is matched with the positioning ring groove in an inserted manner and used for positioning and mounting the rotating disk 73.

In one embodiment, with continued reference to FIG. 18, the lock mechanism 75 includes an annular closure plate 751 fixedly disposed in the accommodating cavity 72, the closure plate 751 is located above the rotating disk 73, and a rotating shaft 752 is rotatably connected to a top surface of the closure plate 751. A lock member 753 is fixedly disposed on a circumferential surface of the rotating shaft 752, and a side of the lock member 753 facing the rotating disk 73 is a tooth surface for increasing friction force between the lock member 753 and the rotating disk 73, thereby ensuring a lock effect of the lock member 753 on the rotating disk 73. The dovetail groove clamp seat 71 is provided with an operating component 754 for pushing the lock member 753 to abut against the rotating disk 73 to lock the rotating disk 73.

In FIG. 18, a connecting component 765 that is integrally connected by a mounting platform, a ball seat and a hemispheroid, and a pushing component 766 for pushing the ball seat to lock the hemispheroid, a threaded hole 712, an elastic member 64, a through hole 7631, a sleeve 7632, a bolt 7633 and a rotary knob 7634 are further included. The connection relationship between these components is shown in FIG. 18, and details are not described herein again.

The objectives, technical solutions, and beneficial effects of the present utility model are further described in detail in the foregoing specific embodiments. It should be understood that the foregoing descriptions are merely specific embodiments of the present utility model, but are not intended to limit the protection scope of the present utility model. Any modification, equivalent replacement, improvement, or the like made within the spirit and principle of the present utility model shall fall within the protection scope of the present utility model.

The descriptions of the above embodiments are only used to help understand the method and its core idea of the present invention. Meanwhile, according to the idea of the present application, there will be changes in the specific implementations and the application scope for a person skilled in the art. In summary, the content of the description should not be understood as a limitation to the present invention.

What is claimed is:

1. A multifunctional conversion seat, comprising:
an adapter base, wherein a first inserting groove is formed in the adapter base, and a switching groove is formed in the bottom of the first inserting groove; and
a switching block, wherein the switching block is rotatably matched with the switching groove, and the switching block can be folded in the switching groove and can also be overturned relative to the switching groove, so as to form a second inserting groove between the switching block and one side of the first inserting groove; and
the first inserting groove and the second inserting groove are respectively used for mounting quick release plates of different specifications in a matched manner.

2. The multifunctional conversion seat according to claim 1, wherein a conversion groove is formed in one side of the switching block;
the switching block is overturned to enable the conversion groove to be opposite to one side of first inserting groove, so as to form the second inserting groove between the side of the first inserting groove and the conversion groove; and
the first inserting groove and the second inserting groove are respectively used for mounting the quick release plate of an ARCA specification and a NATO specification in the matched manner;
alternatively, the first inserting groove and the second inserting groove are respectively used for mounting the quick release plate of a Manfrotto specification and an Arca specification in the matched manner.

3. The multifunctional conversion seat according to claim 1, wherein an expansion groove in communication with one side of the switching groove is formed in the bottom of the first inserting groove.

4. The multifunctional conversion seat according to claim 3, wherein a handheld groove is formed in one side of the switching block, and when the switching block is folded in the switching groove, the handheld groove faces the expansion groove.

5. The multifunctional conversion seat according to claim 1, wherein the adapter base is further provided with a locking assembly, and at least part of the locking assembly is movable relative to the adapter base and is used for locking the quick release plate of camera equipment (or a sliding groove) in the first inserting groove or the second inserting groove.

6. The multifunctional conversion seat according to claim 5, wherein the locking assembly comprises a position adjusting assembly; and
the position adjusting assembly is detachably connected to a side edge of the adapter base, and a space formed for accommodating the quick release plate of the camera equipment can be adjusted by adjusting a distance between the position adjusting assembly and the adapter base.

7. The multifunctional conversion seat according to claim 6, wherein the position adjusting assembly comprises a bearing member, an abutting member, an elastic buffer member, a connecting rod, and a rotary pushing member;
the bearing member is suitable for bearing one side of the camera equipment and is fixedly connected to one side of the first groove, and one end of the bearing member close to the adapter base is connected to the abutting member;
the abutting member is connected to the elastic buffer member, a through hole for accommodating the abutting member and the elastic buffer member is formed in the adapter base, and the abutting member is movably mounted in the through hole;
the elastic buffer member is located in the through hole and is used for buffering the abutting member;
one end of the connecting rod is fixed to the adapter base, and a rod body of the connecting rod penetrates through the bearing member to be detachably connected to the rotary pushing member; and
the rotary pushing member is located on a side of the abutting member away from the adapter base and is used for pushing the abutting member, so as to adjust a distance between the abutting member and two sides of the first groove.

8. The multifunctional conversion seat according to claim 7, wherein the position adjusting assembly further comprises a plane thrust bearing, the plane thrust bearing is sleeved on the connecting rod, and the plane thrust bearing is sleeved between the rotary pushing member and the bearing member.

9. The multifunctional conversion seat according to claim 6, wherein the rotary pushing member comprises a rotating head and a stop nail;
a pushing hole is formed in the rotating head in a penetrating manner along a direction of connecting rod, and the rotating head is rotatably sleeved on the connecting rod through the pushing hole; and
the stop nail is detachably connected to one end of the connecting rod away from the adapter base, and is used for limiting a position of the rotating head.

10. The multifunctional conversion seat according to claim 1, wherein an accommodating groove is formed in the adapter base; and
the accommodating groove is used for accommodating the switching block to rotate, and the switching block is rotatably mounted in the accommodating groove through a rotating shaft.

11. The multifunctional conversion seat according to claim 5, wherein the locking assembly comprises a locking driving member; and
the locking driving member is movably disposed along a direction perpendicular to the first inserting groove, and is used for locking and unlocking the camera equipment inserted into the first inserting groove or the second inserting groove.

12. The multifunctional conversion seat according to claim 10, wherein the locking driving member comprises a locking mechanism, a button unlocking mechanism, and a transition block;
two ends of the transition block are respectively connected to the locking mechanism and the button unlocking mechanism;
the locking mechanism comprises a limiting block, the limiting block is connected to the transition block, and after the switching block is overturned, the conversion groove faces the limiting block;
an accommodating cavity is formed in one side of the adapter base, and an elastic member is disposed between the locking driving member and the adapter base; and
the button unlocking mechanism can compress the elastic member and push the limiting block to slide into the accommodating cavity, and when the elastic member is reset, the limiting block can slide out of the accommodating cavity and abuts against the first inserting groove.

13. The multifunctional conversion seat according claim 12, wherein the button unlocking mechanism comprises a button and a button connecting member;
the button is transversely and slidably matched with the button connecting member, and the button connecting member is connected to the transition block;
a shifting groove is formed in one side of the adapter base, and the button can penetrate out of the shifting groove; and
the button is transversely shifted to enable the button to move in the shifting groove, so that an end portion of the button abuts against the bottom of the shifting groove.

14. The multifunctional conversion seat according claim 13, wherein an end portion of the button connecting member is provided with a positioning concave hole, and one end of the button is provided with a positioning member;
the positioning member comprises a positioning wave bead, a positioning cylinder, and a positioning spring, wherein the positioning cylinder is connected to the button, the positioning spring is located in the positioning cylinder, and the positioning wave bead is connected to the positioning cylinder through the positioning spring; and
the button is transversely shifted to enable the positioning wave bead to be clamped in the positioning concave hole, so as to position the button and the button connecting member.

15. The multifunctional conversion seat according to claim 1, wherein a limiting member is connected to the adapter base, and the limiting member is used for limiting a folding position and an overturning position of the switching block.

16. The multifunctional conversion seat according to claim 15, wherein a first positioning hole and a second positioning hole are formed in an outer side of the switching block;
the limiting member comprises a mounting cylinder, a limiting wave bead and a limiting spring, wherein the limiting spring is located in the mounting cylinder, and two ends of the limiting spring are respectively connected to the mounting cylinder and the limiting wave bead; and
when the switching block is in the folding position, the limiting wave bead can be clamped into the first positioning hole, and when the switching block is in the overturning position, the limiting wave bead can be clamped into the second positioning hole.

17. The multifunctional conversion seat according to claim 1, wherein an inserting block is connected to the bottom of the adapter base; and
a single-side groove is formed between the inserting block and one side of the bottom of the adapter base, and two ends of the single-side groove are communicated with each other.

18. The multifunctional conversion seat according to claim 17, wherein groove notches are formed in two adjacent edges located at the bottom of the inserting block.

19. A universal clamp seat for a stabilizer, comprising the multifunctional conversion seat according to claim according to claim 1, and
a quick release base, wherein the quick release base is connected to the multifunctional conversion seat, access ports are formed in two adjacent edges of one side of the quick release base away from the multifunctional conversion seat, one side of the quick release base away from the multifunctional conversion seat is provided with a quick connection groove, and the quick connection groove is in communication with the access ports.

20. A rotary pan-tilt, comprising a dovetail groove clamp seat, wherein
the bottom of the dovetail groove clamp seat is provided with an accommodating cavity with a downward opening, a rotating disk is rotatably connected to the opening of the accommodating cavity, and a lock mechanism used for being mutually locked with the rotating disk is mounted on the dovetail groove clamp seat; an angle adjusting mechanism is connected to the bottom of the rotating disk, and the angle adjusting mechanism comprises a hemispheroid fixedly connected to the rotating disk, and a base coupled to the hemispheroid; and
the rotating disk supports the multifunctional conversion seat according to claim 1, and can drive the multifunctional conversion seat to rotate, a rotation range corresponds to an angle adjustment range of the angle adjusting mechanism, and the angle adjustment range comprises 360 degrees and non-360 degrees.
